(19) United States
(12) Patent Application Publication
(10) Pub. No.: US 2020/0017300 A1
(43) Pub. Date: Jan. 16, 2020

(54) Systems And Methods For Object Storage And Retrieval

(71) Applicant: Walmart Apollo, LLC, Bentonville, AR (US)

(72) Inventors: Paul Edward Durkee, Centerton, AR (US); Jason D. Shaffer, Bentonville, AR (US); Mark Ibbotson, Bentonville, AR (US); John Suarez, Bentonville, AR (US); Colin Holmes, Bentonville, AR (US)

(21) Appl. No.: 16/510,179

(22) Filed: Jul. 12, 2019

Related U.S. Application Data
(60) Provisional application No. 62/697,025, filed on Jul. 12, 2018.

(51) Int. Cl. B65G 1/137; B65G 1/04; G06Q 10/08

(52) U.S. Cl. CPC B65G 1/1371; G06Q 10/087; B65G 1/1373; B65G 1/045

(57) ABSTRACT

Described in detail herein is an autonomous object storage and retrieval system. In one embodiment, an object storage and retrieval system includes a computing system hosting a service application and in communication with a database and storage towers configured to store and dispense physical objects. Each storage tower is in communication with the computing system and has an octagonal prism-shaped housing. Each storage tower includes, a shelving unit disposed within the housing, the shelving unit configured to one or more of the physical objects, a controller, a transport apparatus, an input device, an interactive display, and a repository. The computing system can transmit instructions to the first storage tower to render the status of the first physical object on the interactive display of the storage tower.

### RELATED APPLICATIONS

This application claims priority to and the benefit of U.S. Provisional Application No. 62/697,025, filed on Jul. 12, 2018, the content of which is incorporated by reference herein in its entirety.

### BACKGROUND

Physical objects can be stored in various locations. Retrieving the physical objects can be inefficient when the location is unknown.

### BRIEF DESCRIPTION OF DRAWINGS

Illustrative embodiments are shown by way of example in the accompanying drawings and should not be considered as a limitation of the present disclosure:

FIG. 1A is a schematic diagram of an exemplary storage tower in accordance with an exemplary embodiment;

FIG. 1B is a schematic diagram of an interior of a storage tower in accordance with an exemplary embodiment;

FIG. 2 is a schematic diagram of an arrangement of storage towers in accordance with an exemplary embodiment;

FIG. 3 is a schematic diagram of a storage receptacle in an storage tower in accordance with exemplary embodiments;

FIG. 4 is a schematic diagram of an exterior of an embodiment of the storage tower in accordance with an exemplary embodiment;

FIGS. 5A-B are exemplary graphical user interfaces (GUI) in accordance with an exemplary embodiment;

FIG. 6 is a block diagram illustrating an autonomous object storage and retrieval system in accordance with an exemplary embodiment;

FIG. 7 is a block diagram illustrating of an exemplary computing device in accordance with an exemplary embodiment;

FIG. 8 is a flowchart illustrating an exemplary process in accordance with an exemplary embodiment; and

FIG. 9 is a flowchart illustrating an exemplary process in accordance with an exemplary embodiment.

### DETAILED DESCRIPTION

Described in detail herein is an autonomous object storage and retrieval system. In one embodiment, an object storage and retrieval system includes a computing system hosting a service application. The computing system can be communication with a database and storage towers configured to store and dispense physical objects. Each storage tower can have an octagonal prism-shaped housing. Each storage tower includes a shelving unit disposed within the housing, a controller, a transport apparatus, an input device, an interactive display, and a repository. The shelving unit is configured to support and store one or more of the physical objects. A first storage tower can receive a first request, via the input device or the interactive display, to dispense a first physical object. The controller can query the repository to determine whether the first physical object is stored in the first storage tower, in response to confirming the first physical object is stored in the first storage tower, the first storage tower can dispense the first physical object, and in response to failing to confirm the first physical object is stored in the first storage tower, the first storage tower can transmit a second request to the service hosted by the computing system to determine a status of the first physical object. The computing system can execute the service in response to receiving the second request; query, via the service, the database to determine the status of the first physical object; and transmit instructions to the first storage tower to render the status of the first physical object on the interactive display of the storage tower. The status can include one or more of: instructions to retrieve the first physical object at a second storage tower, a time frame in which the first physical object will be available, and instructions to retrieve the first physical object at a different location.

The first storage tower is further configured to receive a third request for dispensing a second physical object and a third physical object, and query the repository to determine whether the first physical object is stored in the first storage tower. In response to confirming the second physical object is stored in the first storage tower, the first storage tower dispenses the second physical object, and in response to failing to confirm the third physical object is stored in the first storage tower, the first storage tower transmits a fourth request to the service hosted by the computing system to determine a status of the fourth physical object. The computing system is configured to execute the service in response to receiving the fourth request; query, via the service, the database to determine the status of the fourth physical object; and transmit instructions to the first storage tower to render the status of the fourth physical object on the interactive display of the storage tower.

One or more of the storage towers can be disposed adjacent to or with respect to the first storage tower in a facility. Each storage tower further includes a front storage receptacle defining an opening. In response to confirming the first physical object is stored in the first storage tower, the controller of the first storage tower is configured to control the transport apparatus of the first storage tower to traverse to the shelving unit and pick-up the first physical object, control the transport apparatus to carry the first physical object to the front storage receptacle, and control the transport apparatus to deposit the first physical object in the front storage receptacle, which can eject first physical object from the front storage receptacle through the opening.

A user device can be in communication with the computing system. The computing system can transmit the status of the first physical object to the user device. The repository includes information associated with each physical object stored in the respective storage tower, based on receiving the information while each physical object is loaded into the storage tower.

In one embodiment, the first storage tower can receive a first request to load a first set of physical objects into the first storage tower, and transmit a second request to the service hosted by the computing system to determine a status of the first physical object. The computing system can execute the service in response to receiving the second request; query, via the service, the database to determine the authorization to load the first set of physical object; and transmit instructions to the first storage tower to render a prompt on the interactive display of the storage tower that includes information associated with loading the first set of physical objects.

The computing system can determine based on the query, that the first set of physical objects are related to a second set of physical objects, and that the second physical objects are stored in a second storage tower. The computing system can transmit instructions to the first storage tower to render instructions on the interactive display for loading the first set of physical objects in the second storage tower. The computing system can determine, based on the query, a size of at least one physical object of the first set of physical objects is larger than a specified amount and transmit instructions to the first storage tower to render instructions on the interactive display for storing the first set of physical objects at a different location based on the size of the at least one physical object.

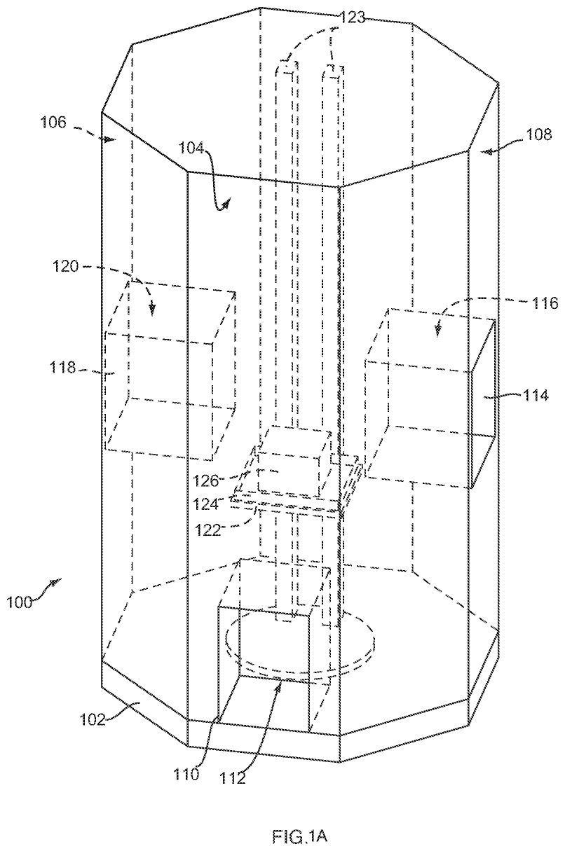

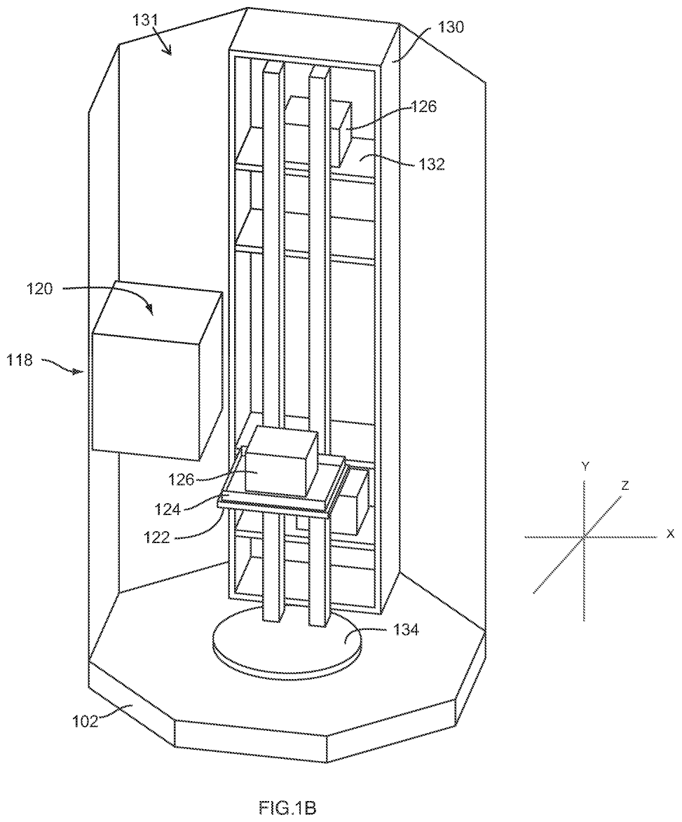

FIG. 1 is a schematic diagram of an exemplary storage tower 100 in accordance with an exemplary embodiment. The storage tower 100 can include housing having a base 102 coupled to side walls or surfaces extending from the base 102. In the present example, the side walls or surfaces of the storage tower 100 can form octagonal cylinder or column such that there are eight side walls or surfaces including a front face 104, a first side face 106, and a second side face 108. A front opening 110 can be disposed on the front face 104. A first side opening 118 can be disposed on the first side face 106. A second side opening can be disposed on the second side face 108. It can be appreciated that the openings, front opening 110, first side opening 118, and second side openings 114, can have retractable doors, windows, or panels to selective cover the openings 110, 114, and 118.

An interior of the storage tower 100 can include a transport apparatus 122 coupled to shafts or railings 123. The transport apparatus 122 can be configured to transport and support the tray 124, which is configured to support physical objects (e.g., the physical object 126). The transport apparatus 122 is further configured to move along the railings 123 along the y-axis. The interior of the storage tower 100 can further include a front storage receptacle 112 aligned with and/or coupled to the front opening 110. A first side storage receptacle 120 can be aligned with and/or coupled to the first side opening 118. A second side storage receptacle 116 can be aligned with and/or coupled to the second side openings 114. The front storage receptacle 112, first side storage receptacle 120, and second side storage receptacle 118 can each include a storage volume, configured to store objects, such as the tray 124 and the physical object 126. The front opening 110, first side opening 118 and second side openings 114 can provide access to the storage volume of the front storage receptacle 112, first side storage receptacle 120, and second side storage receptacle 118, respectively.

FIG. 1B is a schematic diagram of an interior of a storage tower 100 in accordance with an exemplary embodiment. The interior of the storage tower 100 can include eight interior walls 131 defined by the side walls or surfaces of the housing. The interior of the storage tower 100 can include a shelving unit 130, the transport apparatus 122, the railings 123, and a rotating base 134. The railings 123 can be coupled to the rotating base 134. The transport apparatus 122 can be configured to support and transport the tray 124 between a shelf on the shelving unit and one of the storage receptacles. The tray 124 can support the physical object 126. The transport apparatus 122 can be coupled to the railings 123. The transport apparatus 122 can extend perpendicularly from the railings 123. As an example, the transport apparatus 122 can be a pallet. The railings 123 can operate as a boom to lower and raise the transport apparatus 122. The rotating base 134 can rotate the railings 123, and therefore, the transport apparatus 122 360 degrees about a center axis of the rotating base.

The shelving unit 130 can include shelves 132 configured to store and support physical objects 126. The shelving unit 130 can be disposed along one or more of the interior walls 131 of the storage tower 100. For example, the shelving units 130 can be disposed along one interior wall, each interior wall or a subset of the interior walls of the storage tower 100.

As an example, the transport apparatus 122 can receive instructions to load a physical object 126 from the shelving unit 130, onto the transport apparatus 122, and load the physical object 126 into a first side receptacle 120. The rotating base 134 can be configured to rotate the railings 123 circumferentially around the interior of the storage tower 100 so that the railings 123 are parallel to the appropriate shelving unit 130. The transport apparatus 122 can vertically move up and down the railings 123 to align itself with the shelf 132 on which the requested physical object 126 is disposed.

The transport apparatus 122 can pick up the tray 124 supporting the physical object 126. The transport apparatus 122 can traverse along and rotate about the railings 123, transport and deposit the tray 124 and physical object 120 in the first side receptacle 120. The physical object 126 can be stored in the first side receptacle 120, until ejected from the first side opening 118.

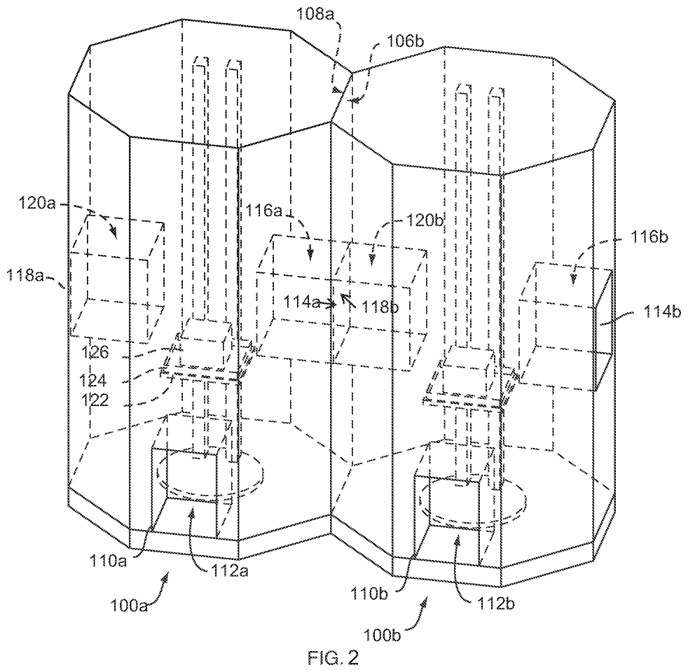

FIG. 2 depicts an exemplary arrangement of storage towers. As a non-limiting example, storage tower 100a can be disposed adjacent to storage tower 100b. The first side face 106a of the storage tower 100a can be aligned with, and adjacent to, the second side face 108b of the storage tower 100b. The second side opening 114b disposed on the second side face 108b of the storage tower 100b can be aligned with, and adjacent to, the first side opening 118a disposed on the first side face 106a of the storage tower 100a. It can be appreciated that the storage towers 100a and 100b can be directly adjacent to one another. Alternatively, storage towers 100a and 100b can be disposed spaced apart from one another. It can be appreciated that any number of storage towers can be disposed within a specified proximity of one another.

In one embodiment, the storage tower 100a or 100b can receive a request to retrieve a physical object 126. The storage tower 100a (or storage tower 100b) can query its own records to confirm whether it is storing the physical object 126. In the event, the storage tower 100a (or storage tower 100b) confirms that it is storing the physical object, the transport apparatus 122, of storage tower 100a (or storage tower 100b), can transport the physical object 126 disposed on the tray 124, to the first side storage receptacle 120a. The transport apparatus 122 can deposit the tray 124 supporting the physical object 126 the front storage receptacle 112a (or storage tower 112b). The tray 124 supporting the physical object 126 can be ejected from the front storage receptacle 112a (or storage tower 112b) through the front opening 110b (or storage tower 110b).

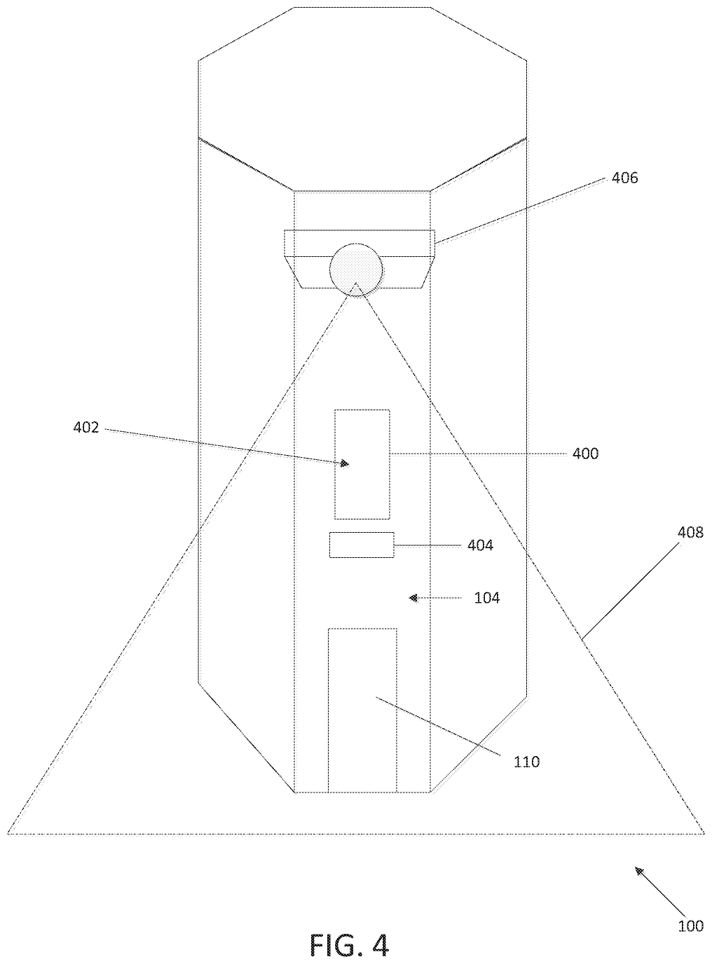

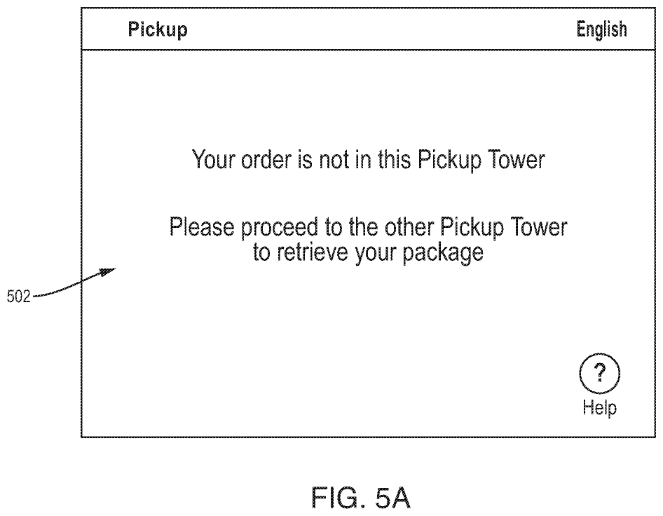

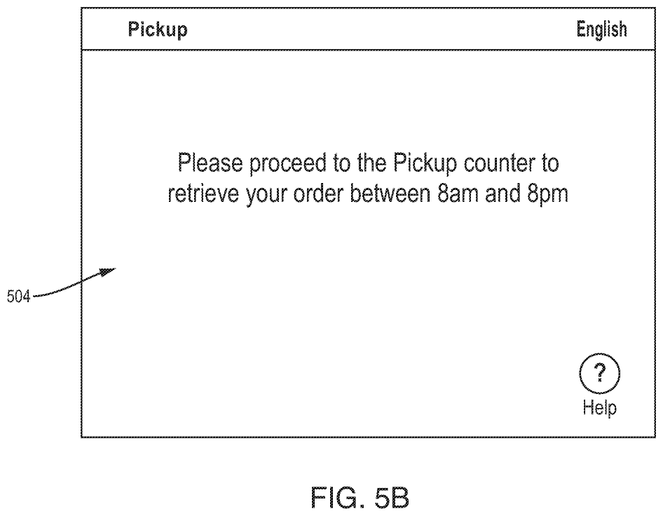

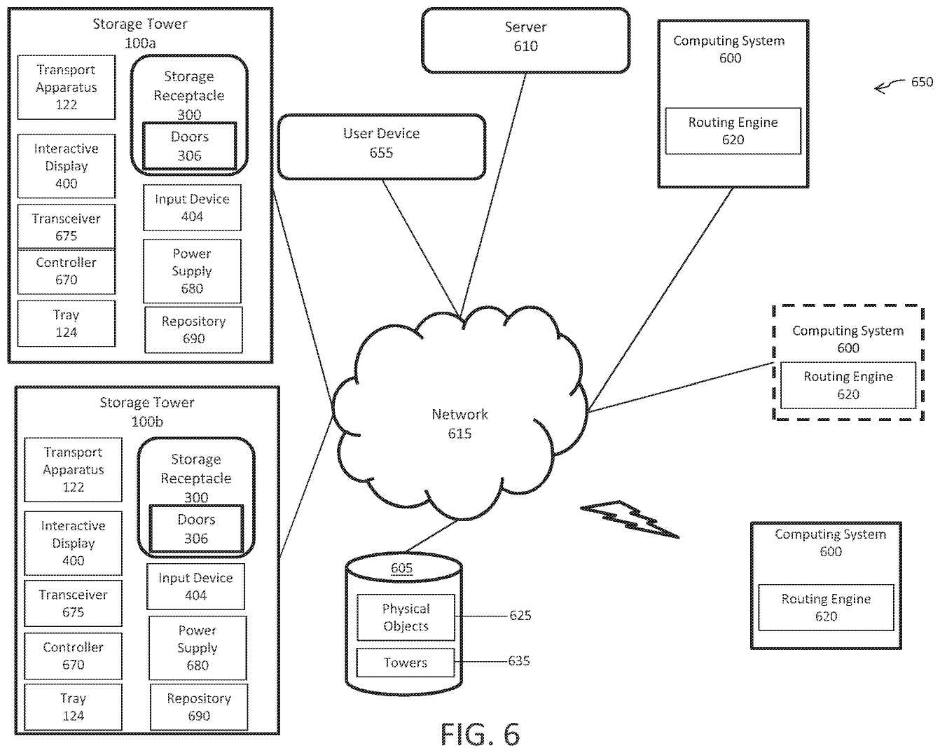

In the event, the storage tower 100a (or storage tower 100b) confirm that it is not storing the physical object, the storage tower 100a (or storage tower 100b) can transmit the request to the computing system. The computing system can instruct the storage tower 100a (or storage tower 100b) to display instructions to the user for retrieving the physical object 126 at a different storage tower. An example computing system is described in further detail with respect to FIG. 6. An example of the display is described in further detail with respects to FIGS. 4-5B.

In one embodiment, storage tower 100b can receive a request for dispensing a physical object 126 disposed in storage tower 100a. The transport apparatus 122, of storage tower 100a, can transport the physical object 126 disposed on the tray 124, to the first side storage receptacle 120a. The transport apparatus 122, of storage tower 100a can deposit the tray 124 supporting the physical object 126 in the first side storage receptacle 120a, of the storage tower 100a.

The tray 124 supporting the physical object 126 can be transferred from the first side storage receptacle 120a, of the storage tower 100b, through the first side opening 118a of the storage tower 100a, through the second side opening 114b into the storage volume of the second side storage receptacle 116b of the storage tower 100b. The tray 124 supporting the physical object 126 can be transferred from the second side storage receptacle 116b to the transport apparatus 122, of the storage tower 100b. The transport apparatus 122 can traverse down the railings 123 and deposit the tray 124 supporting the physical object 126, in the front storage receptacle 112b. The tray 124 supporting the physical object 126 can be ejected from the front storage receptacle 112b through the front opening 110a.

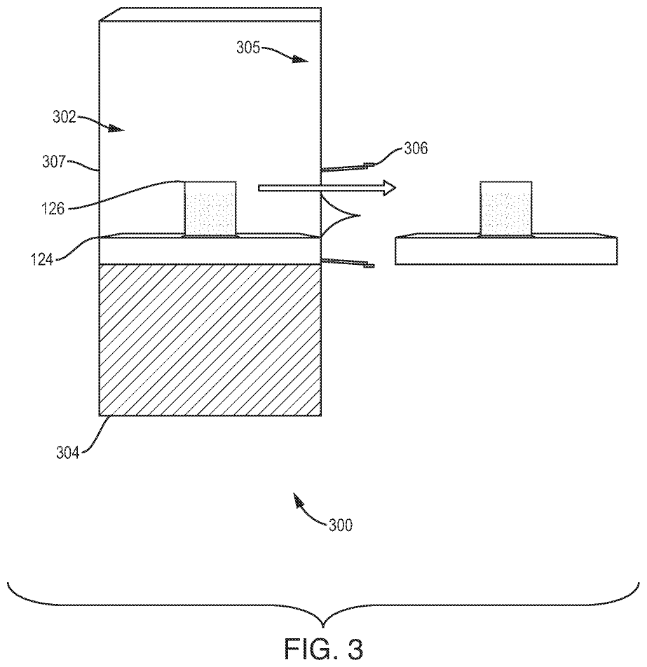

FIG. 3 is a schematic diagram of a storage receptacle 300 in a storage tower in accordance with exemplary embodiments. One or more storage receptacles 300 can be disposed in the storage tower at different locations as described herein. For example, the storage receptacle 300 can be disposed in a front, a first side, or a second side of the storage tower. The storage receptacle 300 can include an interior storage volume 302 and a base 304 within the interior storage volume 302. The base 304 can support a tray 124, which can support a physical object 126. A first (front) side 305 of the storage receptacle 300 can include a door 306. A second (back) side 307 of the storage receptacle 300 can be an open face. The storage receptacle 100 can be configured to receive and eject the tray 124 and physical object 126 from the door 106 on the front side and through the open face of the back side 107. The door 306 can be a sliding door (sliding horizontally or vertically), a rotating door, a hinged door, and/or a double door.

FIG. 4 is a schematic diagram of an exterior of an embodiment of the storage tower 100 in accordance with an exemplary embodiment. An interactive display 400 can be disposed on the storage tower 100. The interactive display 400 can be disposed on the front surface 104 with respect to the front opening. An input device 404 can also be disposed on the storage tower. The input device 404 can be disposed on the front surface 104 with respect to the front opening 110. The input device 404 can be one or more of, an optical scanner, a keyboard/keypad, and image capturing device.

The interactive display 400 can render a graphical user interface (GUI) 402. The GUI 402 can display information associated with a request for dispensing a physical object through the front opening of the storage tower. As an example, a user can input information associated with a request for dispensing a physical object. The information can be an identifier, a name, a username, a pin number or any suitable information that can be used to identify the physical object to be retrieved or stored. As a non-limiting example, the user can enter the information, via a touchscreen display incorporated in the interactive display 402. Alternatively, or in addition to, the interactive display 402 can have multiple input devices such as a keyboard, mouse, joystick, touchpad, or other devices configured to interact with the interactive display 402, such as the input device 404. The user can input identification information using the input device 404

The user can also scan a machine-readable element encoded with an identifier associated with the physical object, using the input device 404. As an example, the input device 404 can be an optical scanner or an image capturing device. The input device 404 can scan/capture and decode the identifier from the machine-readable element. The machine-readable element can be a barcode or a QR code. The input device 404 can transmit the identifier to the interactive display. The interactive display 400 can receive the information associated with the request and transmit the information to a computing system, an example of which is described in greater detail with respect to FIG. 6.

In one embodiment, a motion sensor 406 can be disposed on the front surface 104 of the storage tower 100. The motion sensor can detect a user approaching the storage tower 100, within a given field-of-view or radius 408. The doors of the front opening 110 can automatically open in response to the motion sensor 406 detecting a user approaching the storage tower 100. Alternatively, or in addition to, the interactive display 402 can be powered down (in energy saving mode) and in response to the motion sensor detecting a user entering the radius 408, the interactive display 402 can be powered on.

In one embodiment, the user can request to dispense a physical object, disposed in the storage tower 100 or another storage tower. The user can input identification information associated with the using the interactive display 400 and/or input device 404. The identification information can be transmitted to the computing system. The computing system can instruct the storage tower 100 in which the physical object is disposed to dispense the physical object. In the event the physical object is disposed in the storage tower 100, the storage tower 100 can dispense the physical object through the front opening 110 of the storage tower 100. In the event the physical object is stored in a different storage tower, the computing system can instruct the storage tower 100 to display a graphical user interface (GUI) rendering instructions on the interactive display 402 for retrieving the physical object from a different tower or location. The instructions can include the location of the different tower and/or a time frame in which the physical object may be available for retrieval.

FIGS. 5A-5B illustrates exemplary graphical user interfaces (GUIs) to be rendered on a display of a storage tower. With reference to FIG. 5A, GUI 502 can be rendered on the interactive display (i.e., interactive display 402 as shown in FIG. 4). The GUI 502 can include information indicating instructions for retrieving a physical object at a different storage tower. With reference to FIG. 5B, GUI 504 can be rendered on the interactive display of a storage tower. The GUI 504 can include information indicating instructions for retrieving a physical object at a different location and/or at a different time.

FIG. 6 illustrates an exemplary autonomous object storage and retrieval system 650 in accordance with an exemplary embodiment. The autonomous object storage and retrieval system 650 can include one or more databases 605, one or more servers 610, one or more computing systems 600, storage towers 100a-b, and one or more user devices 655. The routing engine 620 can implement the autonomous object storage and retrieval system 650.

In an example embodiment, one or more portions of the communications network 615 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 610 includes one or more computers or processors configured to communicate with the computing system 600, the databases 605, storage towers 100a-b, and user devices 655 via a communications network 615. The server 610 hosts one or more applications configured to interact with one or more components computing system 600 and/or facilitates access to the content of the databases 605. The databases 605 may store information/data, as described herein. For example, the databases 605 can include physical objects database 625 and a towers database 635. The physical objects database 625 can store information associated with physical objects. The towers database 635 can store information associated with the storage towers location and physical object disposed in the storage towers. The databases 605 can be located at one or more geographically distributed locations from the computing system 600. Alternatively, the databases 605 can be located at the same geographically as the computing system 600.

The storage towers 100a-b can each include one or more of the storage receptacles 300, the transport apparatus 122, the tray 124, the interactive display 400, the input device 404, the controller 670, the transceiver 675, and the repository 690. The one or more storage receptacles 300 can each include a door 306. The storage towers 100 can also be coupled to a power source 680. The power source 680 can provide power to the transport apparatus 122, door 306, interactive display 400, input device 404, controller 670, transceiver 675, and repository 690. The transceiver 675 can transmit and receive data, via the network 615. The controller 670 can control the operations of transport apparatus 122, door 306, interactive display 400, and input device 404, based on received data from the transceiver 675. The repository 690 can store information associated with physical objects stored in the respective storage tower 100a or 100b.

In an exemplary embodiment, a user can request a physical object to be dispensed at storage tower 100a or 100b. As an example, the user can input identification information associated with the physical object at the interactive display 400 and/or input device 404 of storage tower 100a. The controller 670 of storage tower 100a can receive the identification information and query the repository 690 of storage tower 100a to confirm whether the requested physical object is deposited in the storage tower 100a. In the event the requested physical object is stored in the storage tower 100a, the controller 670 can prompt the interactive display 400 to render a confirmation message. The controller 670 can control the transport apparatus 122 to retrieve the requested physical object disposed on a tray 124, transport the physical object to the (front) storage receptacle 300, and dispense the physical object disposed on the tray 124 in the (front) storage receptacle 300. The tray 124 supporting the physical object can be ejected through the door 306 of the storage receptacle 300. The controller 670 can delete the identification information of the requested physical object from the repository 690.

In the event the controller 670 is unable to confirm the physical object is disposed in the storage tower 100a. The controller 670 can call a service by transmitting the request the computing system 600. The computing system 600 can execute the routing engine 620 in response to receiving the request. The routing engine 620 can query the towers database 635 to determine the location of the physical object. The routing engine 620 can determine the requested physical object is stored in the storage tower 100b, based on the query. The routing engine 620 can transmit instructions to the storage tower 100a to render instructions to the user to retrieve the physical object at storage tower 100b. In response to the transceiver 675 of the storage tower 100a receiving the instructions, the controller 670 of the storage tower 100a can instruct the interactive display 400 of the storage tower 100a to render the instructions to the user to retrieve the requested physical object at storage tower 100b.

In one embodiment, in the event the routing engine 620 is unable to determine the location of the requested physical object, the routing engine 620 can query the physical objects database 625 to retrieve information associated with the requested product. Based on the query, the routing engine 625 can determine, the physical object has not been loaded into a storage tower and is not yet available to be retrieved. Continuing with the earlier example, the routing engine 625 can transmit instructions to the storage tower 100a to render a prompt informing the user that the physical object is not available to retrieved, a time frame to retrieve the physical object, and/or a location to retrieve the physical object. In response to the transceiver 675 of the storage tower 100a receiving the instructions, the controller 670 of the storage tower 100a can instruct the interactive display 400 of the storage tower 100a to render the prompt informing the user that the physical object is not available to retrieved, a time frame to retrieve the physical object, and/or a location to retrieve the physical object.

In one embodiment, the routing engine 620 can transmit the instructions to retrieve a physical object at a different storage tower and/or a prompt informing the user that the physical object is not available for retrieval, a time frame to retrieve the physical object, and/or a location to retrieve the physical object to a user device (i.e., via SMS, e-mail, push notification).

As a non-limiting example, the autonomous object storage and retrieval system 650 can be implemented in a retail store environment. The storage towers 100a-b can be disposed in a retail store. The user can be customers requesting to retrieve products from the retail store. The products can be pre-purchased or purchased at the storage towers 100a-b. In one embodiment, an employee of the retail store can load a product for storage in the storage tower 100a or 100b in response to a customer's order. As an example, the employee can input employee login (user credential) information at the interactive display 404 and/or input device 404. Once authenticated, the employee can input identification information associated with the product at the interactive display 400 and/or input device 404 of storage tower 100a. The controller 670 of storage tower 100a can receive the identification information and store the identification information in the repository 690 of the storage tower 100a. The controller 670 can control the transport apparatus 122 to navigate to a (front) storage receptacle 300, and receive the physical object disposed on a tray 124 in the (front) storage receptacle 300. The transport apparatus 122 can transport the tray 124 supporting the physical object to a shelving unit in storage tower 100a for storage.

In one embodiment, a customer's order can include a first product and a second product. The employee can input identification information associated with the second product at the interactive display 400 and/or input device 404 of the storage tower 100a, to load the second product in storage tower 100a. The controller 670 can call a service by transmitting the request to load the second product to the computing system 600. The computing system 600 can execute the routing engine 620 in response to receiving the request. The computing system 600 can query the towers database 635 to determine the location of the first product. Based on the query, the routing engine 620 can determine the first product is located in the storage tower 100b. The routing engine 620 can transmit instructions to the storage tower 100a to render instructions to the employee to load the second physical object in storage tower 100b. In response to the transceiver 675 receiving the instructions, the controller 670 can instruct the interactive display 400 to render the instructions to the employee to load the second physical object in storage tower 100b. In one embodiment, the routing engine 620 can determine the second product has already been loaded into storage tower 100b or 100b. The routing engine 620 can transmit instructions to the storage tower 100a to render a prompt to the employee that the second product has already been loaded into storage tower 100a or 100b. In response to the transceiver 675 receiving the instructions, the controller 670 can instruct the interactive display 400 of storage tower 100a or 100b to render prompt to the employee that the second product has already been loaded into storage tower 100a or 100b.

In one embodiment, based on the query the routing engine 620 can determine the size of a physical object is too big to load into the storage tower 100a or 100b. The routing engine 620 can transmit instructions to the storage tower 100a or 100b to render instructions to the employee to store the physical object at a different location due to the size of the physical object, on the interactive display.

In one embodiment, a customer can request an order including a first product, second product and third product. The first and second product can be stored in storage tower 100b. The third product may be too large to store in either storage tower 100a or 100b. In response to receiving a request to retrieve the order, the routing engine 620 can transmit instructions to the storage tower 100a or 100b to render a prompt to the customer that the third product is too large to be stored in the storage tower 100a or 100b and can be retrieved at a different location in the retail store. In response to the transceiver 675 receiving the instructions, the controller 670 can instruct the interactive display 400 of storage tower 100a or 100b to render a prompt to the customer that the third product is too large to be stored in the storage tower 100a or 100b and can be retrieved at a different location in the retail store. Alternatively or in addition to, in the event products from the order are stored in various storage towers 100a-b, the routing engine 620 can transmit instructions to the storage tower 100a or 100b to render a prompt to the customer indicating which products are stored at which storage towers. In response to the transceiver 675 receiving the instructions, the controller 670 can instruct the interactive display 400 of storage tower 100a or 100b to render a prompt to the customer indicating which products are stored at which storage towers.

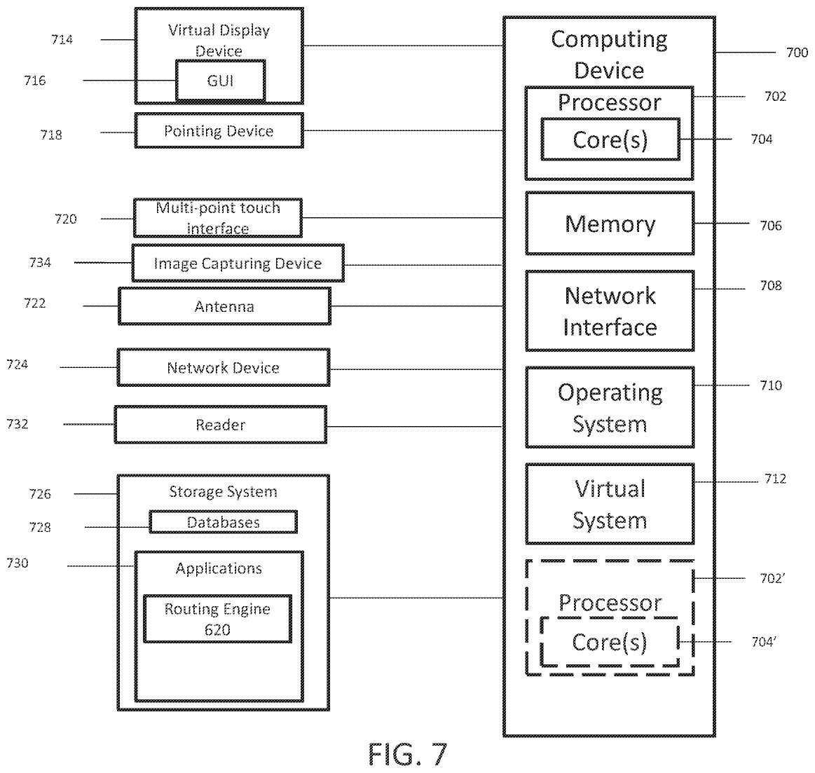

FIG. 7 is a block diagram of an example computing device for implementing exemplary embodiments of the present disclosure. The computing device 700 may be, but is not limited to, a smartphone, laptop, tablet, desktop computer, server or network appliance. The computing device 700 can be embodied as part of the computing system, user device, or storage tower. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 706 included in the computing device 700 may store computer-readable and computer-executable instructions or software (e.g., applications 730 such as the routing engine 620) for implementing exemplary operations of the computing device 700. The computing device 700 also includes configurable and/or programmable processor 702 and associated core(s) 704, and optionally, one or more additional configurable and/or programmable processor(s) 702′ and associated core(s) 704′ (for example, in the case of computer systems having multiple processors/cores), for executing computer-readable and computer-executable instructions or software stored in the memory 706 and other programs for implementing exemplary embodiments of the present disclosure. Processor 702 and processor(s) 702′ may each be a single core processor or multiple core (704 and 704′) processor. Either or both of processor 702 and processor(s) 702′ may be configured to execute one or more of the instructions described in connection with computing device 700.

Virtualization may be employed in the computing device 700 so that infrastructure and resources in the computing device 700 may be shared dynamically. A virtual machine 712 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof.

A user may interact with the computing device 700 through a visual display device 714, such as a computer monitor, which may display one or more graphical user interfaces 716, multi touch interface 720, a pointing device 718, an image capturing device 734 and a scanner 732.

The computing device 700 may also include one or more computer storage devices 726, such as a hard-drive, CD-ROM, or other computer readable media, for storing data and computer-readable instructions and/or software that implement exemplary embodiments of the present disclosure (e.g., applications). For example, exemplary storage device 726 can include one or more databases 728 for storing information regarding physical objects and the storage towers. The databases 728 may be updated manually or automatically at any suitable time to add, delete, and/or update one or more data items in the databases.

The computing device 700 can include a network interface 708 configured to interface via one or more network devices 724 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 722 to facilitate wireless communication (e.g., via the network interface) between the computing device 700 and a network and/or between the computing device 700 and other computing devices. The network interface 708 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

The computing device 700 may run any operating system 710, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 700 and performing the operations described herein. In exemplary embodiments, the operating system 710 may be run in native mode or emulated mode. In an exemplary embodiment, the operating system 710 may be run on one or more cloud machine instances.

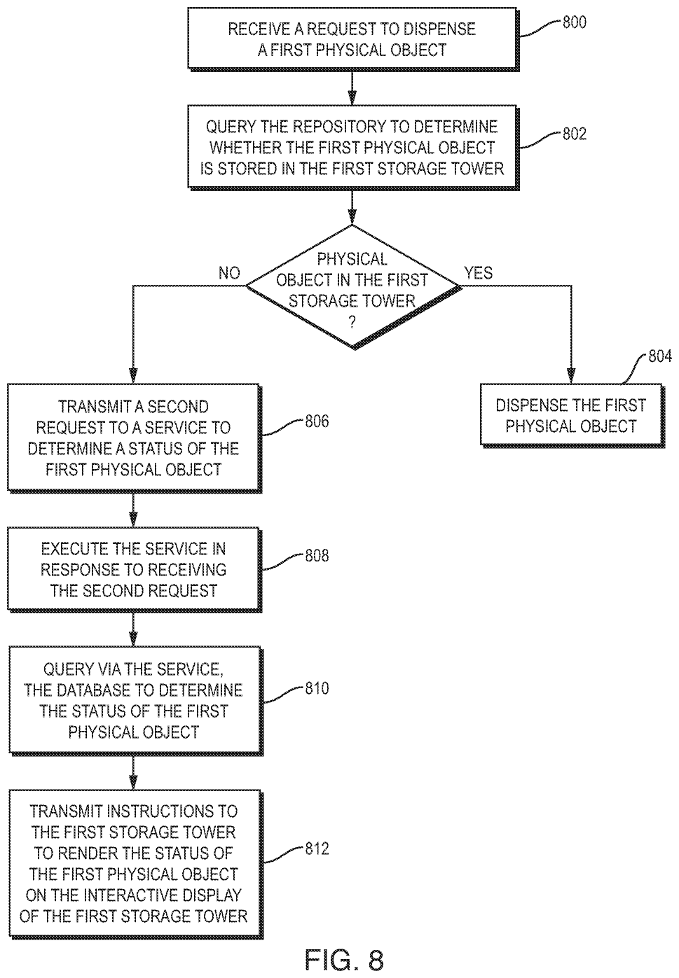

FIG. 8 is a flowchart illustrating a process of the autonomous storage and retrieval system according to exemplary embodiment. In operation 800, an input device (e.g., input device 404 as shown in FIGS. 4 and 6) or interactive display (e.g., interactive display 400 as shown in FIGS. 4 and 6) of a first storage tower (e.g., storage tower 100, 100a, 100b, as shown in FIG. 1A-B, 2, 4, and 6) of a plurality of storage towers can receive a request to dispense a first physical object (e.g., physical objects 126 as shown in FIGS. 1A-3). Each of the plurality of storage towers is in communication with a computing system (e.g., computing system 600 as shown in FIG. 6). Each storage tower has an octagonal prism-shaped housing and includes, a shelving unit (e.g., shelving unit 130 as shown in FIG. 1B) disposed within the housing, a controller (e.g., controller 670 as shown in FIG. 6), a transport apparatus (e.g., transport apparatus 122 as shown in FIGS. 1A-B, 2 and 6), the input device, the interactive display, and a repository (e.g., repository 655 as shown in FIG. 6). The shelving unit is configured to support and store one or more physical objects. In operation 802, the storage tower can query the repository to determine whether the first physical object is stored in the first storage tower. In operation 804, in response to confirming the first physical object is stored in the first storage tower, the first storage tower can dispense the first physical object. In operation 806, in response to failing to confirm the first physical object is stored in the first storage tower, the first storage tower can transmit a second request to a service (e.g., routing engine 620 as shown in FIG. 6) hosted by the computing system to determine a status of the first physical object.

In operation 808, the computing system can execute the service in response to receiving the second request. In operation 810 the computing system can query via the service, the database to determine the status of the first physical object. In operation 812, the computing system can transmit instructions to the first storage tower to render the status of the first physical object on the interactive display of the first storage tower.

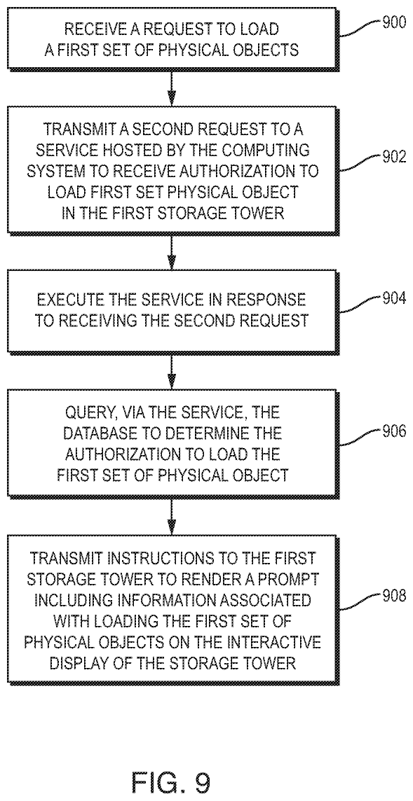

FIG. 9 is a flowchart illustrating the process of the autonomous storage and retrieval system according to exemplary embodiment. In operation 900, an input device (e.g., input device 404 as shown in FIGS. 4 and 6) or interactive display (e.g., interactive display 400 as shown in FIGS. 4 and 6) a first storage tower (e.g., storage tower 100, 100a, 100b, as shown in FIG. 1A-B, 2, 4, and 6) of a plurality of storage towers can receive a first request to load a first set of physical objects into the first storage tower (e.g., physical objects 126 as shown in FIGS. 1A-3). Each storage tower has an octagonal prism-shaped housing and includes, a shelving unit (e.g., shelving unit 130 as shown in FIG. 1B) disposed within the housing, a controller (e.g., controller 670 as shown in FIG. 6), a transport apparatus (e.g., transport apparatus 122 as shown in FIGS. 1A-B, 2 and 6), the input device, the interactive display, and a repository (e.g., repository 655 as shown in FIG. 6). The shelving unit is configured to support and store one or more physical objects. In operation 902, the first storage tower can transmit a second request to a service (e.g., routing engine 620 as shown in FIG. 6) hosted by the computing system to receive authorization to load the first set of physical objects.

In operation 904, the computing system can execute the service in response to receiving the second request. In operation 906, the computing system can query, via the service, the database to determine the authorization to load the first set of physical object. In operation 908, the computing system can transmit instructions to the first storage tower to render a prompt including information associated with loading the first set of physical objects on the interactive display of the first storage tower.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An object storage and retrieval system, the system comprising:
a computing system hosting a service application, the computing system in communication with a database;
a plurality of storage towers configured to store and dispense a plurality of physical objects, each of the plurality of storage towers in communication with the computing system, each of the plurality of storage towers having an octagonal prism-shaped housing and including, a shelving unit disposed within the housing, a controller, a transport apparatus, an input device, an interactive display, and a repository, wherein the shelving unit is configured store to one or more of the plurality of physical objects, and a first storage tower of the plurality of storage towers is configured to:
receive a first request, via the input device or the interactive display, to dispense a first physical object of the plurality of physical objects;
query the repository of the first storage tower to determine whether the first physical object is stored in the first storage tower;
in response to confirming the first physical object is stored in the first storage tower, dispensing the first physical object;
in response to failing to confirm the first physical object is stored in the first storage tower, transmit a second request to the service application hosted by the computing system to determine a status of the first physical object;
wherein the computing system is configured to:
execute the service application in response to receiving the second request;
query, via the service application, the database to determine the status of the first physical object; and
transmit instructions to the first storage tower to render the status of the first physical object on the interactive display of the first storage tower.

2. The system of claim 1, wherein the status can include one or more of: instructions to retrieve the first physical object at a second storage tower, a time frame in which the first physical object will be available at the first storage tower, or instructions to retrieve the first physical object at a different location.

3. The system of claim 1, wherein the first storage tower is configured to:
receive a third request for dispensing a second physical object and a third physical object;
query the repository of the first storage repository to determine whether the second and third physical objects are stored in the first storage tower;
in response to confirming the second physical object is stored in the first storage tower, dispensing the second physical object; and
in response to failing to confirm the third physical object is stored in the first storage tower, transmit a fourth request to the service application hosted by the computing system to determine a status of the third physical object.

4. The system of claim 3, wherein the computing system is configured to:
execute the service application in response to receiving the fourth request;
query, via the service application, the database to determine the status of the third physical object; and
transmit instructions to the first storage tower to render the status of the third physical object on the interactive display of the storage tower.

5. The system of claim 1, wherein at least a second storage tower of the plurality of storage towers is disposed adjacent to or with respect to the first storage tower.

6. The system of claim 1, wherein each of the plurality of storage towers further includes a front storage receptacle defining an opening.

7. The system of claim 6, wherein in response to confirming the first physical object is stored in the first storage tower, the controller of the first storage tower is configured to:
control the transport apparatus to traverse to the shelving unit and pick-up the first physical object;
control the transport apparatus to carry the first physical object to the front storage receptacle;
control the transport apparatus to deposit the first physical object in the front storage receptacle;
eject first physical object from the front storage receptacle through the opening.

8. The system of claim 1, further comprising a user device in communication with the computing system.

9. The system of claim 8, wherein the computing system is configured to transmit the status of the first physical object to the user device.

10. The system of claim 1, wherein the repository includes information associated with each physical object stored in the respective storage tower, based on receiving the information while each physical object is loaded into the storage tower.

11. An object storage and retrieval method, the method comprising:
receiving, via an input device or an interactive display of a first storage tower of a plurality of storage towers, a first request to dispense a first physical object of the plurality of physical objects, each of the plurality of storage towers in communication with a computing system, having an octagonal prism-shaped housing, and including a shelving unit disposed within the housing, a controller, a transport apparatus, the input device, the interactive display, and a repository, the shelving unit configured to store one or more of the plurality of physical objects;
querying, via the first storage tower, the repository to determine whether the first physical object is stored in the first storage tower;
in response to confirming the first physical object is stored in the first storage tower, dispensing, via the first storage tower, the first physical object;
in response to failing to confirm the first physical object is stored in the first storage tower, transmitting, via the first storage tower, a second request to a service hosted by the computing system to determine a status of the first physical object;
executing, via the computing system, a service in response to receiving the second request;
querying, via the service on the computing system, a database to determine the status of the first physical object; and
transmitting, via the service on the computing system, instructions to the first storage tower to render the status of the first physical object on the interactive display of the first storage tower.

12. The method of claim 11, wherein the status can include one or more of: instructions to retrieve the first physical object at a second storage tower, a time frame in which the first physical object will be available at the first storage tower, or instructions to retrieve the first physical object at a different location.

13. The method of claim 11, further comprising:
receiving, via the first storage tower, a third request for dispensing a second physical object and a third physical object;
querying, via the first storage tower, the repository of the first storage repository to determine whether the second and third physical objects are stored in the first storage tower;
in response to confirming the second physical object is stored in the first storage tower, dispensing, via the first storage tower, the second physical object; and
in response to failing to confirm the third physical object is stored in the first storage tower, transmitting, via the first storage tower, a fourth request to the service application hosted by the computing system to determine a status of the third physical object.

14. The method of claim 13, further comprising:
executing, via the computing system, the service application in response to receiving the fourth request;
querying, via the service on the computing system, the database to determine the status of the third physical object; and
transmitting, via the service on the computing system, instructions to the first storage tower to render the status of the third physical object on the interactive display of the storage tower.

15. The method of claim 11, wherein at least a second storage tower of the plurality of storage towers is disposed adjacent to or with respect to the first storage tower.

16. The method of claim 11, wherein each of the plurality of storage towers further includes a front storage receptacle defining an opening.

17. The method of claim 16, further comprising in response to confirming the first physical object is stored in the first storage tower:
controlling, via the controller of the first storage tower, the transport apparatus to traverse to the shelving unit and pick-up the first physical object;
controlling, via the controller of the first storage tower, the transport apparatus to carry the first physical object to the front storage receptacle;
controlling, via the controller of the first storage tower, the transport apparatus to deposit the first physical object in the front storage receptacle;
ejecting, via the controller of the first storage tower, first physical object from the front storage receptacle through the opening.

18. The method of claim 11, wherein a user device is in communication with the computing system.

19. The method of claim 18, further comprising transmitting, via the computing system, the status of the first physical object to the user device.

20. The method of claim 11, wherein the repository includes information associated with each physical object stored in the respective storage tower, based on receiving the information while each physical object is loaded into the storage tower.

21. An object storage and retrieval system, the system comprising:
a computing system hosting a service application and in communication with a database;
a plurality of storage towers configured to store and dispense a plurality of physical objects, each of the plurality of storage towers in communication with the computing system, each of the plurality of storage towers having an octagonal prism-shaped housing and including, a shelving unit disposed within the housing, a controller, a transport apparatus, an input device, an interactive display, and a repository, wherein the shelving unit is configured store to one or more of the plurality of physical objects, and a first storage tower of the plurality of storage towers is configured to:
receive a first request to load a first set of physical objects into the first storage tower;
transmit a second request to the service application hosted by the computing system to receive authorization to load first set of physical object in the first storage tower;
wherein the computing system is configured to:
execute the service application in response to receiving the second request;
query, via the service application, the database to determine the authorization to load the first set of physical object; and
transmit instructions to the first storage tower to render a prompt including information associated with loading the first set of physical objects on the interactive display of the first storage tower.

22. The system of claim 19, wherein computing system is configured to:
determine based on the query, the first set of physical objects are related to a second set of physical objects and the second physical objects are stored in a second storage tower of the plurality of storage towers; and
transmit instructions to the first storage tower to render instructions for loading the first set of physical objects in the second storage tower, on the interactive display.

23. The system of claim 19, wherein the computing system is configured to:
determine based on the query, a size of at least one physical object of the first set of physical objects is larger than a specified amount;
transmit instructions to the first storage tower to render instructions for storing the first set of physical objects at a different location based on size of the at least one physical object, on the interactive display.
